(19) United States
(12) Patent Application Publication
(10) Pub. No.: US 2005/0253354 A1
(43) Pub. Date: Nov. 17, 2005

(54) Horizontal shock suspension system

(75) Inventors: Joseph K. Riley, El Cajon, CA (US); Giovanni G. Spinali, El Cajon, CA (US)

Correspondence Address: Crockett & Crockett;Suite 400, 24012 Calle De La Plata, Laguna Hills, CA, 92653, US

(73) Assignee: Rize Industries, LLC

(21) Appl. No.: 10/846,355

(22) Filed: May 14, 2004

(51) Int. Cl. B60G 1/00

(52) U.S. Cl. 280/124.153; 280/124.165; 280/124.116

(57) ABSTRACT

A horizontally mounted vehicle suspension system is provided. The suspension system contains at least one horizontally mounted shock, which provides for a more comfortable ride within the vehicle. The configuration increases the space to accommodate for the shock or shock strut, as well as allows for the use of full travel shocks in small spaces. The full shock length, with all associated benefits can be used within a smaller space. The suspension system may be used with traditional shock absorbers or shock struts.

### FIELD OF THE INVENTIONS

The inventions described below relate the field of auxiliary frame systems for a vehicle wheel suspension system.

### BACKGROUND OF THE INVENTION

Conventional suspension systems for cars and trucks comprise shock absorbers or shock struts that are mounted vertically within the suspension system. The vertically mounted shock absorbers fits easily into the wheel well.

With the vertical shock suspension systems, the size of the shock absorbers is limited by the available space in the wheel well. This results in limited travel of the entire shock as well as limited damping. Where a small area is defined, the lowering or raising of the vertical shock mounts has been a solution. Alternatively, shorter shocks may be used, however, this results in less ability to prevent bouncing of the vehicle. A common way to lower a vehicle for improved handling or appearance is to install shorter springs and shocks. However, the use of shorter springs results in reduced travel and stiffer spring thus resulting in some loss of ride quality. Too much lowering causes a very harsh ride, poor handling, and possible suspension damage.

The use of lift kits has become a popular modification of truck suspension systems. With trucks, particularly off-road trucks, the lift kits are advantageous because they provide for more damping than regular shock suspension systems. Additionally, the use of the lift kits allows the truck suspension system to standout in the wheel well and attract attention. To accommodate shock absorbers in a lifted truck, and provide for the installation of additional shock absorbers for each wheel, a shock hoop is attached to the frame of the truck and shocks are attached in a vertical orientation from the top of the shock hoop. However, the vertical orientation of shock absorbers in some configurations limits travel of the shock absorbers. These disadvantages have been overcome by the horizontal shock absorber systems described below.

### SUMMARY OF THE INVENTION

The devices and methods described below provide for installation of horizontally mounted shock absorbers for cars and trucks. The horizontally mounted suspension system provides for greater damping efficiency in the small area of the wheel well. Additionally, the use of full travel shocks in an area where they were previously not able to be used results in less bottoming out of the shocks.

The suspension system includes a shock hoop, at least one horizontally oriented shock absorber, a pivot arm, at least one vertically oriented shock transfer rod, and a control arm. The shock hoop is adapted to be mounted to both the vehicle frame and to the shock absorber of the vehicle. The shock is oriented horizontally within the suspension system, attached securely to the vehicle frame at one end, and attached to the pivot arm at the other end. The pivot arm is rotatably mounted to the shock hoop at its center, and secured to the shock transfer rod at its other end. The shock transfer rod connects the pivot arm to the wheel, and is fixed at its lower end to the upper or lower control arm (for typical two-wheel drive and four-wheel drive front end suspensions), the axle (for rear suspensions or front end suspensions on four wheel drive trucks) or other structure fixed to the wheel. Finally, a shock transfer rod connects the pivot arm to the axle of the vehicle. The pivot arm functions to translate the horizontal movement of the shock transfer rod into the shock.

The shock transfer rod is positioned vertically so that it is perpendicular to the shock absorber. When the vehicle is in operation, the bouncing motion of the vehicle is received at the shock transfer rod and then transmitted through the shock transfer rod, through the pivot arm, to the shock absorber. The shock then absorbs the bouncing motion in order to maintain a smooth ride within the truck.

Linkage, pivot points, and the shock absorber are key in preserving a smooth ride within the truck. Vehicle springs maintain ride height, effect body motion (such as pitch and roll) and they affect ride quality and adhesion. The pivot arm is contained for control of the suspension when the truck is operated. The pivot arm is positioned to project transversely from the suspension and is adapted to be attached to the shock and the shock transfer rod. The shock transfer rod functions to transmit movement of the wheel to the suspension. The shock is positioned transversely with respect to the shock transfer rod. This configuration results in a horizontally mounted suspension system. The system is especially well suited for use with off road trucks, and for use with lift kits, where additional absorption is desirable.

### BRIEF DESCRIPTION OF THE DRAWINGS

FIG. 1 illustrates a horizontal shock suspension system installed on a truck; and

FIG. 2 illustrates the horizontal shock suspension system.

### DETAILED DESCRIPTION OF THE INVENTIONS

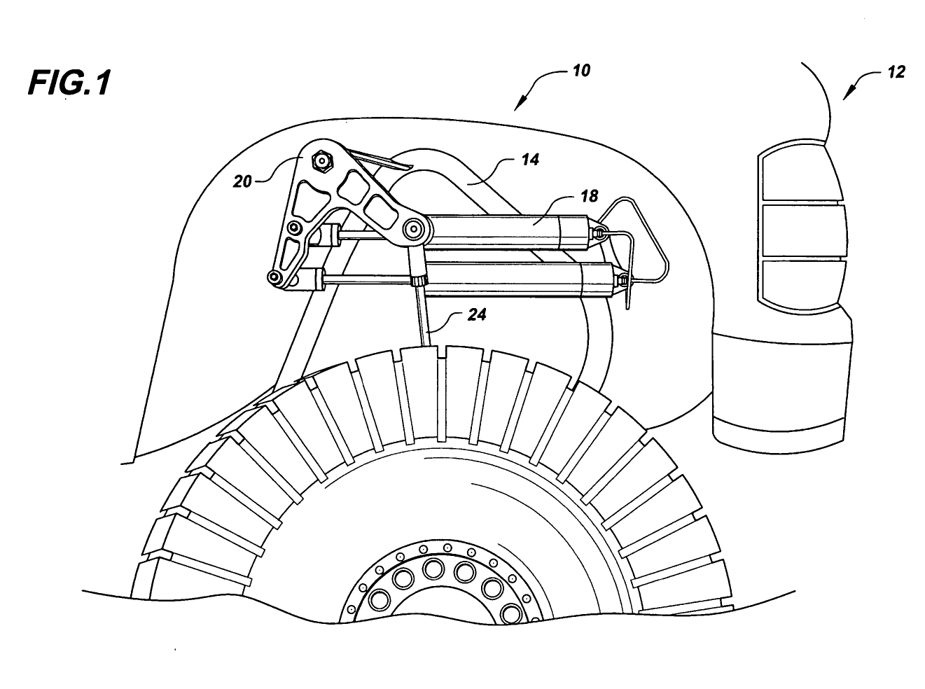

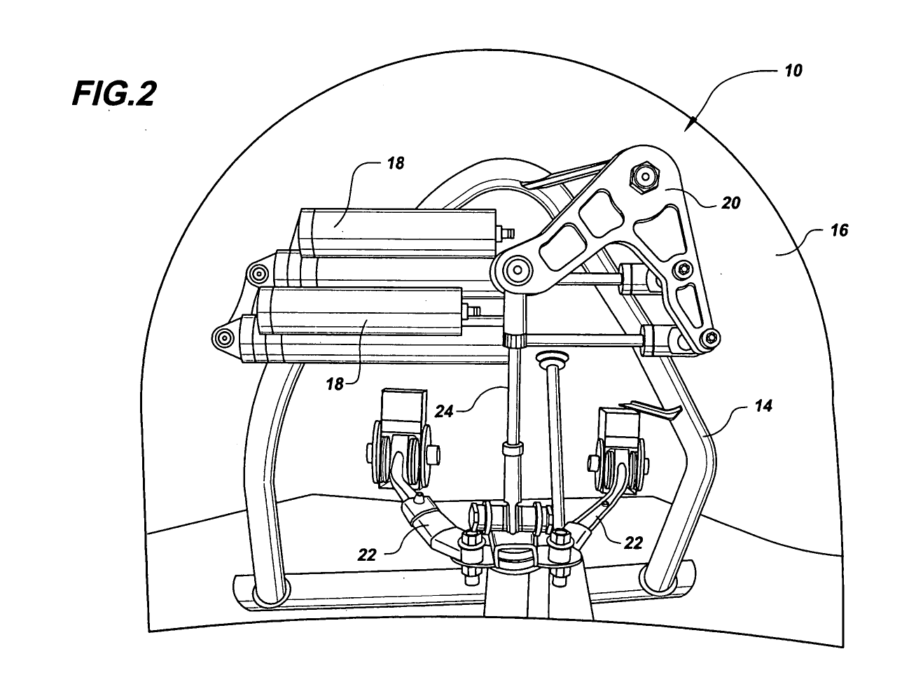

FIGS. 1 and 2 illustrate a horizontal shock suspension system 10 installed on a truck 12. The suspension system 10 comprises a shock hoop 14 that is fixedly attached to the frame 16 of a truck or automobile, two shock absorbers 18, a pivot arm 20, and upper control arm 22, and a shock transfer rod 24.

The shock hoop 14 comprises a generally “U” shape tube or rod with fitting on either end adapted to be fixed to the frame or subframe of the truck. The shock hoop serves primarily as a means for securing shock absorbers to the frame in place of the original equipment shock absorber mounts fixed to the frame above the wheel well. The shock hoop extends from a convenient point on the frame, in this case it extends upwardly from a point below the upper end of the vertically oriented shock absorbers with which it is typically used, and also below the horizontally oriented shock absorbers 18. The shock hoop is modified with the provision of a mounting bracket adapted for mounting of the shock absorbers, and a mounting bracket adapted for mounting of the pivot arm. Other shapes and configurations of alternative shock absorber mounts may be used, but the selected shape must be able to fit within the wheel well. For example, the shock hoop may be a plate or boss fixed to the frame and extending downwardly from a point above the shock absorbers or outwardly from the frame from a point on the frame at the same level as the shock absorbers. Though the shock hoops currently in use are shaped as inverted U's, any shape may be used. The shock hoop may take the form of any type of securing brace that can be both mounted to the car or truck frame and support the load imparted by the suspension system. Typically the shock hoop is bolted to the frame. However, it may be welded or attached by any other suitable means. The number of attachment points to the frame may vary according to how much load needs to be distributed across the shock hoop. The shock hoop can be comprised of a unitary or sectional or multi link frame.

A pair of typical shock absorbers 18 provide shock absorption for the truck. (Though the system is illustrated with two shock absorbers, one, two or more shock absorbers may be used. Each shock is attached at one end to the shock hoop, through a rotatable joint connected to the shock absorber actuator rod. If desired, multiple shocks may be used to achieve greater damping of the system. FIGS. 1 and 2 illustrate a shock system that uses two shocks mounted parallel to each other, vertically spaced, at some distance from each other. Standard size shocks may be used with the system. Because of the horizontal orientation of the shocks, there is more room in the wheel well so that the full travel of the shock may be realized. Alternatively, struts or any other suitable damping means or shock absorbing means may be used in place of the shock absorbers. If more than one shock absorber is installed, then each shock is connected to the pivot arm at some distance from each other. The shocks are positioned in a horizontal direction such that the shocks are positioned approximately parallel to the ground (when the car is in a flat, ground level position).

The pivot arm 20 connects the shock absorbers to the shock transfer rod, and allows for translation of upward movement of the transfer rod into horizontal translation of the shock absorber actuator rods. The length of the pivot arm, and the distance from the pivot point may be adjusted to control suspension, ratio, and stroke of the suspension system. Other shapes may be utilized, but the selected shape must be able to accommodate for multiple connection points as follows. The pivot arm is rotatably mounted to the shock hoop at the pivot point. At a point or points spaced from the pivot point, the pivot arm is secured to the second end of the shocks. The pivot arm is mounted at a third point to the top of the shock transfer rod 24.

The shock transfer rod 24 is a generally elongate rigid rod. The top of the shock transfer rod is attached to the pivot arm 20. The bottom of the shock transfer rod is attached to the wheel, preferably indirectly via attachment to the upper control arm, lower control arm, or axle. When more than one control arm is contained in the suspension system, the shock transfer rod may be attached at an intermediate point to the second control arm. Wheel motion is received through the shock transfer rod 24 and translated up through the vertical structure of the rod. At the connection point of the shock transfer rod to the pivot arm 20, the movement is translated into the shocks 18 and therefore translated into horizontal motion within the system.

The system is further contains a control arm 22. This arm connects the wheel to the frame of the car or truck. The arm 22 is of a generally wishbone shaped structure and contains pivot points at each end. The arm is used to pivotally attach the wheel assembly to the frame. Pivot points at the ends of the arm allow for necessary suspension motion and steering movements of the wheels. Control arms come in many different forms. However, the significant feature of the arms is not their particular form, but their ability to fix the fore/aft and lateral location of the wheels and while allowing vertical movement and steering of the wheels. The control arm is mounted to the mainframe or the subframe of the vehicle at one end and to the wheel, through the steering knuckle. The control arm is also vertically fixed to the bottom end of the shock transfer rod at a point near the wheel end. The control arm assemblies are pivotally operably connected to the frame or subframe. The control arms are comprised of two generally transversely (relative to the vehicle) extending arm members that are pivotally attached to the frame or subframe of the vehicle.

The horizontal shock suspension system 10 can be used with either a car or a truck. The horizontal shock suspension system may comprise shock absorbers or shock struts and optionally springs. Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

1. A horizontally mounted truck suspension system for controlling movement of a wheel of a truck comprising:
a shock hoop rigidly attached to the frame of the truck;
at least one horizontal shock absorber with first and second ends, wherein the first end of the shock is mounted to the shock hoop;
a pivot arm with first and second ends, said pivot arm adapted to be attached at the first end to the shock;
at least one control arm with first and second ends mounted at the first end to the wheel of the truck and at the second end to the frame of the truck; and
a vertical shock transfer rod with first and second ends adapted to be attached at the first end to the second end of the pivot arm and at the second end to the control arm of the truck;
wherein the shock is positioned substantially perpendicular to the shock transfer rod within the truck suspension system;
wherein the shock transfer rod translates vertical movement from the wheel into compression to the horizontally mounted shock.

2. The system of claim 1 wherein the pivot arm is attached at a third intermediate point to the shock hoop.

3. The system of claim 1 further comprising a second control arm mounted at some distance from the first control arm, and connected at one end to the shock transfer rod and at the other end to the frame of the truck.

4. The system of claim 1 further comprising a second shock with first and second ends, wherein the shock is mounted to the shock hoop and to the pivot arm at the second end and wherein the second cushion shock is positioned at some distance from the first shock and perpendicular to the shock transfer rod.

5. The system of claim 4 wherein the shocks further comprise coil springs disposed about the shocks.

6. A horizontally mounted truck suspension system for controlling movement of a wheel of a truck comprising:
a substantially rigid brace attached to the frame of the truck;
horizontally mounted damping means with first and second ends, wherein the first end of the damping means is mounted to the brace;
a means for translating vertical movement into compression adapted to be attached at a first end to the second end of the damping means;
at least one control arm with first and second ends mounted at the first end to the wheel of the truck and at the second end to the frame of the truck; and
a vertical shock transfer rod with first and second ends adapted to be attached at the first end to the second end of the translation means and at the second end to the control arm of the truck;
wherein the damping means are positioned substantially perpendicular to the shock transfer rod within the truck suspension system;
wherein the shock transfer rod translates vertical movement from the wheel to compression to the horizontally mounted damping means.

7. The system of claim 6 further comprising a second control arm mounted at some distance from the first control arm, and connected at one end to the shock transfer rod and at the other end to the frame of the truck.

8. A method of controlling movement of a wheel in a vehicle comprising:
providing a support means rigidly attached to the frame of the vehicle;
attaching horizontally mounted damping means with first and second ends to one end of the support means;
attaching the first end of a means for translating movement to the second end of the damping means;
attaching at least one control arm having first and second ends to the wheel of the vehicle at one end and to the frame of the vehicle at the second end;
attaching the first end of a vertical shock transfer rod to the second end of the means for translating movement and the second end of the shock transfer rod to the second end to the control arm of the vehicle; and
orienting the damping means so that it is perpendicular to the vertical shock transfer rod within the vehicle suspension system so that the vertical shock transfer rod translates vertical movement from the wheel into compression movement to the horizontally mounted damping means.

9. The method of claim 8 further comprising attaching a second control arm having first and second ends to the shock transfer rod at one and the vehicle at the second end.
